(19) United States
(12) Patent Application Publication
(10) Pub. No.: US 2017/0032335 A1
(43) Pub. Date: Feb. 2, 2017

(54) BETTING TICKET SALES MEDIATION DEVICE, BETTING TICKET SALES MEDIATION METHOD, AND PROGRAM FOR BETTING TICKET SALES MEDIATION DEVICE

(71) Applicant: RAKUTEN, INC., Tokyo (JP)

(72) Inventor: Sadaaki EMURA, Setagaya-ku (JP)

(73) Assignee: Rakuten, Inc., Tokyo (JP)

(21) Appl. No.: 15/303,315

(22) PCT Filed: Sep. 30, 2014
(86) PCT No.: PCT/JP2014/076108

§ 371 Date: Oct. 11, 2016

(51) Int. Cl. G06Q 20/04; G06Q 20/40; G07F 17/32; G06Q 50/34

(52) U.S. Cl. CPC G06Q 20/045; G06Q 50/34; G06Q 20/407; G07F 17/3288; G07F 17/3244; G07F 17/3225

(57) ABSTRACT

A cancellation request of a purchased betting ticket including information that specifies a first user purchasing the betting ticket, a betting type, and a buying target of the betting ticket is accepted from the first user; after acceptance of the cancellation request, when accepting from a second user a purchase of a betting ticket of a betting type and a buying target same as the betting type and the buying target of the betting ticket receiving the cancellation request from the first user, an amount is deposited in an account of the first user depending on an amount of a betting ticket receiving the cancellation request from the first user and an amount of a betting ticket accepted from the second user; and information indicating that the cancellation request is established is output for the first user when the amount to be deposited is not zero.

### TECHNICAL FIELD

The present invention relates to technical fields of betting ticket sales mediation devices, betting ticket sales mediation methods, and programs for the betting ticket sales mediation devices that perform the sale of betting tickets for racing.

### BACKGROUND ART

Regarding the purchase of a betting ticket of a racing such as a horse racing and a bicycle racing, various services such as purchasing a betting ticket from a terminal connected to a network and acquiring information on a race can be received. For example, Patent Document 1 discloses a booking betting management server capable of changing or cancelling the booked betting contents before the race is started.

### CITATION LIST

### Patent Document

Patent Document 1: JP 2005-322151 A

### SUMMARY OF THE INVENTION

### Problem to be Solved by the Invention

However, a betting ticket can be cancelled only in a case where the host system of the host is directly accessible, and therefore it has been impossible to cancel at the terminal in net sales, an off-track betting office, and the like.

The present invention has been made in view of such problems, and an example of the object is to provide a betting ticket sales mediation device and the like capable of cancelling the betting ticket without a cancellation request to the host system of the host.

### Means for Solving the Problem

In order to solve the above problems, the invention according to claim 1 is characterized in that a betting ticket sales mediation device that accepts a purchase of a betting ticket of a racing from a user terminal, and transmits betting ticket purchase information not including information about a name of a user purchasing the betting ticket to a host server device hosted by the racing, the betting ticket sales mediation device includes: a cancellation acceptance means that accepts a cancellation request of the purchased betting ticket including information that can specify a first user purchasing the betting ticket and a betting type and a buying target of the purchased betting ticket from a user terminal of the first user; a deposit means that deposits in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and an output means that outputs, for the first user, information indicating that the cancellation request is established when the determined amount to be refunded is not zero.

Therefore, the refund can be performed to the account of the first user depending on the amount of the betting ticket receiving the cancellation request from the first user and the amount of the betting ticket of the same betting type and buying target accepted from the second user, and therefore the cancellation of the betting ticket can be performed without the cancellation request to the host system of the host.

The invention according to claim 2 is characterized in that the betting ticket sales mediation device according to claim 1 further includes a transmission information determination means that determines, when an amount of the betting ticket receiving the cancellation request accepted from the first user is less than an amount of a betting ticket of the same betting type and buying target accepted from the second user, to transmit betting ticket purchase information not including information on the name based on a difference between these purchase amounts to the host server device.

In this case, only the difference is transmitted, whereby the cancellation can be achieved without any cancellation request to the host system of the host. In addition, there is no need to notify the host of the purchase amount of the second user, and therefore the reduction in traffic can be achieved.

The invention according to claim 3 is characterized in that in the betting ticket sales mediation device according to claim 1 or 2, when an amount of the betting ticket receiving the cancellation request accepted from the first user is larger than an amount of the betting ticket of the same betting type and buying target accepted from the second user, the deposit means deposits an amount of the betting ticket of the same betting type and buying target accepted from the second user in an account of the first user.

In this case, the betting ticket purchase information on the purchase amount from the second user does not need to be transmitted to the host side, and the purchase amount of the second user is refunded to the first user as a partial refund, whereby the cancellation can be partly performed.

The invention according to claim 4 is characterized in that in the betting ticket sales mediation device according to claim 3, with respect to a betting ticket of the same betting type and buying target, when a total amount of amounts of betting tickets in the cancellation requests accepted from a plurality of users including the first user is larger than an amount of the betting ticket of the same betting type and buying target accepted from the second user, the deposit means deposits, in an account of each of the users, an amount depending on each time of cancellation requests accepted from the plurality of users in a purchase amount of the betting ticket of the same betting type and buying target accepted from the second user.

In this case, the partial cancellation can be performed due to the refund with a sense of fairness depending on the time of the cancellation request with respect to each user requesting the cancellation.

The invention according to claim 5 is characterized in that in the betting ticket sales mediation device according to claim 3, with respect to a betting ticket of the same betting type and buying target, when a total amount of amounts of betting tickets in the cancellation requests accepted from a plurality of users including the first user is larger than an amount of the betting ticket of the same betting type and buying target accepted from the second user, the deposit means deposits, in an account of each of the users, an amount depending on user information of each user in the plurality of users in an amount of the betting ticket of the same betting type and buying target accepted from the second user.

In this case, the refund in accordance with a predetermined reference depending on the user information of each user is performed to each user requesting the cancellation, whereby the partial cancellation with a sense of fairness can be performed.

The invention according to claim 6 is characterized in that a betting ticket sales mediation method of a betting ticket sales mediation device that accepts a purchase of a betting ticket of a racing from a user terminal, and transmits betting ticket purchase information not including information about a name of a user purchasing the betting ticket to a host server device hosted by the racing, the betting ticket sales mediation method includes: a cancellation acceptance step of accepting, from a first user, a cancellation request of the purchased betting ticket including information that can specify the first user purchasing the betting ticket and a betting type and a buying target of the purchased betting ticket; a deposit step of depositing in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and an output step of outputting, for the first user, information indicating that the cancellation request is established when the amount to be deposited is not zero.

The invention according to claim 7 is characterized in that a program for a betting ticket sales mediation device that accepts a purchase of a betting ticket of a racing from a user terminal, and transmits betting ticket purchase information not including information about a name of a user purchasing the betting ticket to a host server device hosted by the racing, the program causes a computer to function as: a cancellation acceptance means that accepts, from a first user, a cancellation request of the purchased betting ticket including information that can specify the first user purchasing the betting ticket and a betting type and a buying target of the purchased betting ticket; a deposit means that deposits in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and an output means that outputs, for the first user, information indicating that the cancellation request is established when the amount to be deposited is not zero.

### Effect of the Invention

According to the present invention, the refund can be performed to the account of the first user depending on the amount of the betting ticket receiving the cancellation request from the first user and the amount of the betting ticket of the same betting type and buying target accepted from the second user, and therefore the cancellation of the betting ticket can be performed without the cancellation request to the host system of the host.

### BRIEF DESCRIPTION OF THE DRAWINGS

FIG. 1 is a schematic diagram illustrating an example of a schematic configuration of a betting ticket sales mediation system according to an embodiment of the present invention.

FIG. 2 is a schematic diagram illustrating a relationship among a betting ticket sales mediation server, a host server of the host, and a terminal device in FIG. 1.

FIG. 3 is a block diagram illustrating an example of a schematic configuration of the betting ticket sales mediation server in FIG. 1.

FIG. 4 is a schematic diagram illustrating an example of a purchase betting ticket database of the betting ticket sales mediation server in FIG. 3.

FIG. 5 is a block diagram illustrating an example of a general configuration of the host server in FIG. 1.

FIG. 6 is a block diagram illustrating an example of a general configuration of the terminal device in FIG. 1.

FIG. 7 is a flowchart illustrating an operation example of the betting ticket sales mediation system in FIG. 1.

FIG. 8 is a schematic diagram illustrating an example of a display of the terminal device in FIG. 1.

FIG. 9 is a schematic diagram illustrating an example of the purchase of a betting ticket of another user after cancellation of the betting ticket.

FIG. 10 is a schematic diagram illustrating an example of the purchase of a betting ticket of another user after cancellation of the betting tickets of a plurality of persons.

### MODES FOR CARRYING OUT THE INVENTION

In the following, the embodiments of the present invention will be described with reference to the accompanying drawings. Incidentally, the embodiment described below is an embodiment in which the present invention is applied to the betting ticket sales mediation system.

### [1. Configuration and Schematic Function of Betting Ticket Sales Mediation System]

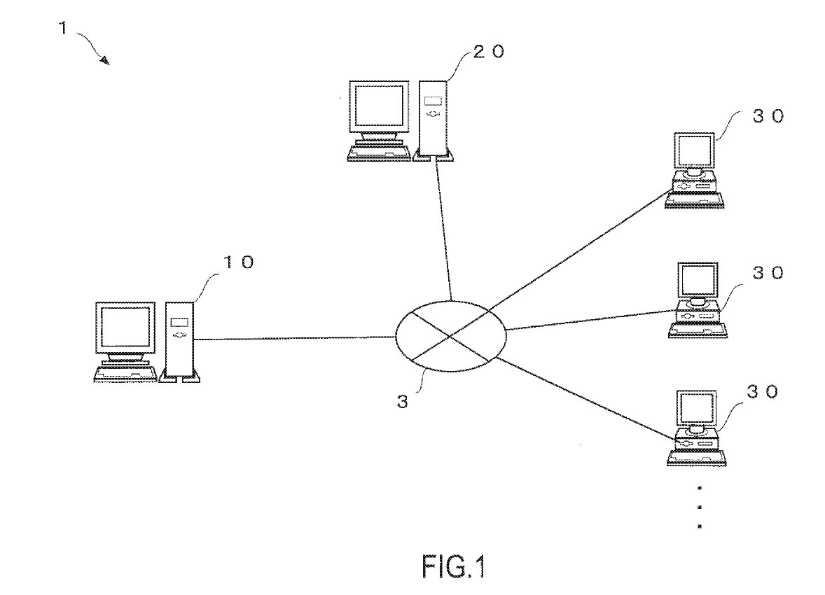

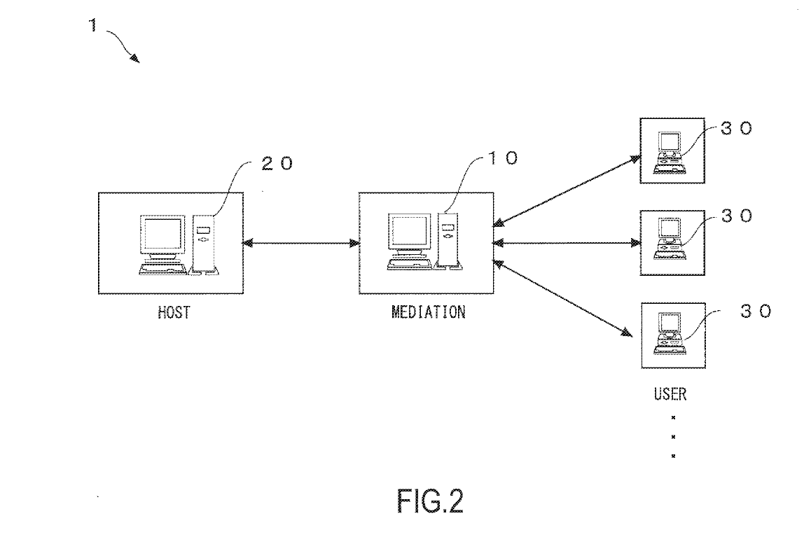

First, the configuration and the schematic function of the betting ticket sales mediation system according to an embodiment of the present invention will be described with reference to FIGS. 1 and 2.

FIG. 1 is a schematic diagram illustrating an example of a schematic configuration of the betting ticket sales mediation system 1 according to the present embodiment. FIG. 2 is a schematic diagram illustrating a relationship among a betting ticket sales mediation server 10, a host server 20 of the host, and a terminal device 30.

As illustrated in FIG. 1, the betting ticket sales mediation system 1 includes a betting ticket sales mediation server 10 that provides information about the betting ticket and performs the mediation of the sale of the betting ticket in the racing such as horse racing, bicycle racing, and motorboat racing (an example of the betting ticket sales mediation device), a host server 20 on the host side that organizes or operates the racing and issues betting tickets, and a terminal device 30 for the user to purchase the betting ticket on the competition (race) in response to the provision of information from the betting ticket sales mediation server 10 (an example of the user terminal).

The betting ticket sales mediation server 10, the host server 20, and the terminal device 30 are connected to each other by a network 3, and can transmit and receive data with a communication protocol (for example, TCP/IP). The network 3 is constructed by the Internet, a private communication line (for example, community antenna television (CATV) line), a mobile communication network (including base stations and others), a gateway, and others, for example. Incidentally, the betting ticket sales mediation server 10 and the host server 20 may be connected to each other by a private line to improve security.

The betting ticket sales mediation server 10 receives from the host server information announced by the host such as the odds of a race, the condition of a racecourse, information on racers such as horses, bicycles, or boats to participate in a race, and the result of a race. The betting ticket sales mediation server 10 outputs to the terminal devices 30 information to assist purchase of betting tickets by users at the terminal devices 30. The betting ticket sales mediation server 10 performs processing such as reception of purchase of betting tickets, and payout for a winning betting ticket to each terminal device 30. Thus, the betting ticket sales mediation server 10 is a server for operating a racing site such as a horse racing site. The purchase of the betting ticket of the racing is accepted from a plurality of terminal devices 30, and the betting ticket purchase information not including the information about the name of a user who purchases the betting ticket is transmitted to the host server 20 hosted by the racing.

The host server 20 performs the issuing processing of the betting ticket, and totalizes the odds to perform the announcing processing based on the issued betting ticket, with respect to the betting ticket sales mediation server 10, the terminal device installed in the racecourse and the betting ticket office, and the like.

There exist a plurality of terminal devices 30 of users, each of which displays the information for purchase of a betting ticket, and transmits the information about the betting ticket to be purchased to the betting ticket sales mediation server 10.

As illustrated in FIG. 2, each terminal device 30 is configured to be connected to the betting ticket sales mediation server 10 to be capable of transmitting and receiving data. In addition, the betting ticket sales mediation server 10 is configured to be connected to the host server 20 to be capable of transmitting and receiving data. The betting ticket sales mediation server 10 accepts the purchase of the betting tickets together with the user ID of each terminal device 30 (an example of the user's name) from each terminal device 30, totalizes them for each race, betting type, and buying target, and generates the summary data without name information. The betting ticket sales mediation server 10 transmits the generated summary data to the host server 20.

In addition, the host server 20 calculates the odds depending on the betting ticket purchase total amount from an unspecified large number of betting persons including the summary data from the betting ticket sales mediation server 10. Therefore, in the summary data transmitted by the betting ticket sales mediation server 10, the information about who bought how much is not needed, and therefore the name information such as the user ID is not included.

The host server 20 accepts the betting ticket purchase from an unspecified large number of betting persons in racecourses and off-track betting offices including the summary data from the betting ticket sales mediation server 10, and performs the calculation of odds and the like, rather than managing the betting from the user specified by the user ID.

Here, odds refer to a dividend rate (a rate on stakes), and include those successively announced as approximate odds before the start of a race, and those announced as fixed odds (final odds fixed finally) after the close of betting ticket sale. There are odds for each betting ticket type (type of betting method, a so-called betting type) of the betting tickets, and for each buying target (buying target composed of a racer number of a racer) that designates one or more racers out of racers to participate in a race. That is, there are odds for each betting ticket corresponding to a buying target and a betting type. Incidentally, racers in a race may include horse jockeys, or participants who control or steer bicycles or boats.

Examples of betting types of betting tickets include win in which a racer predicted to finish first is designated, exacta in which racers predicted to finish first and second are designated in the correct order, trifecta in which racers predicted to finish first, second, and third are designated in the correct order, place in which a single racer predicted to finish first to third or first to second is designated, quinella in which two racers predicted to finish first to second are designated, bracket quinella in which brackets including racers predicted to finish first to second are designated, quinella place wide in which two racers predicted to finish first to third are designated, a trio in which three racers predicted to finish first to third are designated, and others.

A buying target includes, for a win, the number of a racer predicted to finish first, for an exacta, the numbers of racers predicted to finish first and second, for a trifecta, the numbers of racers predicted to finish first, second, and third, for a quinella, a combination of two designated racer numbers, for a bracket quinella, a combination of two designated bracket numbers (corresponding to the racer numbers of racers included in the brackets), for a quinella place wide, a combination of two designated racer numbers, for a trio, a combination of three designated racer numbers, and for a consecutive win, a single designated racer number.

### [2. Configuration and Function of Each Server]

### (2.1 Configuration and Function of Betting Ticket Sales Mediation Server 10)

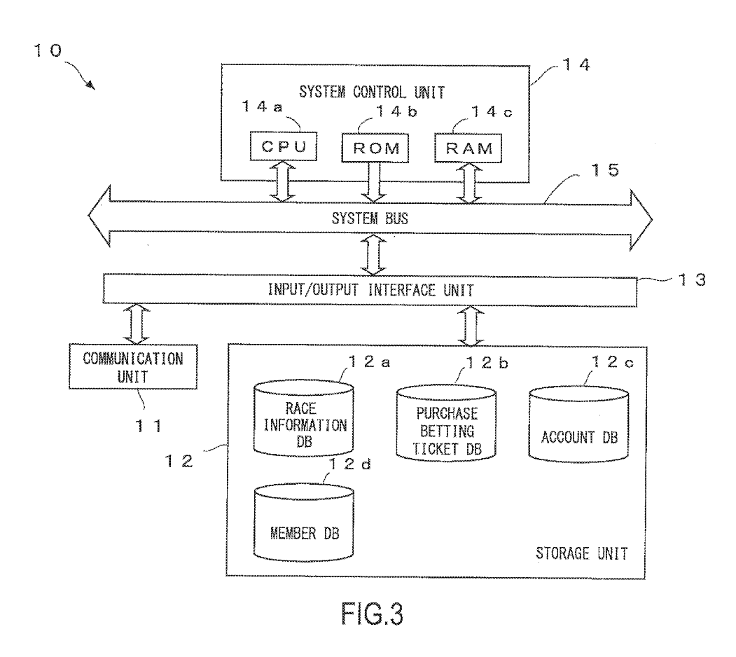

Next, the configuration and function of the betting ticket sales mediation server 10 will be described with reference to FIG. 3.

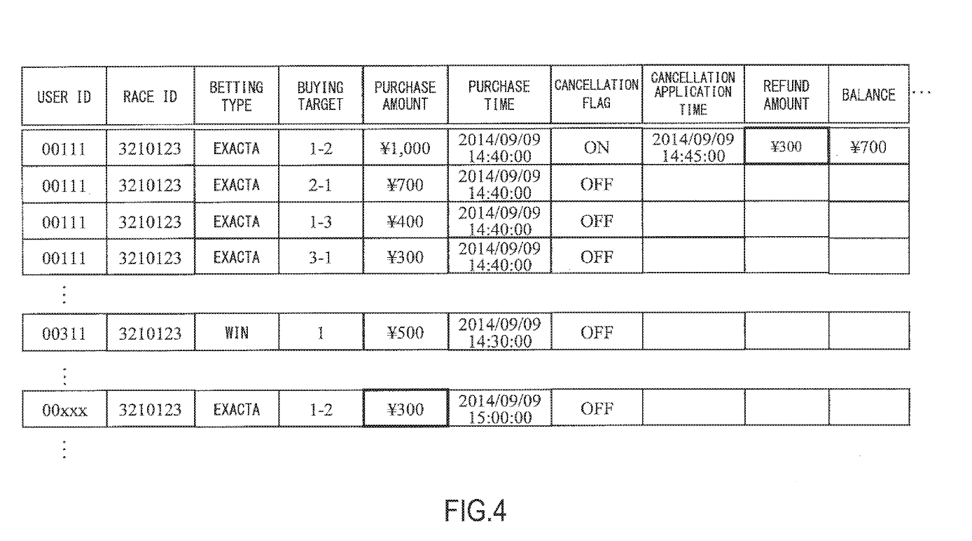

FIG. 3 is a block diagram illustrating an example of a schematic configuration of the betting ticket sales mediation server 10. FIG. 4 is a schematic diagram illustrating an example of a purchase betting ticket database of the betting ticket sales mediation server 10.

As shown in FIG. 3, the betting ticket sales mediation server 10 functioning as a computer includes a communication unit 11, a storage unit 12, an input/output interface unit 13, and a system control unit 14. The system control unit 14 and the input/output interface unit 13 are connected to each other via a system bus 15.

The communication unit 11 connects to the network 3 and controls the state of communication with the host server 20, the terminal devices 30, and others, and further connects to a local area network and performs transmission and reception of data to and from other servers on the local area network.

The storage unit 12 is formed by a hard disk drive or the like, for example, and stores various programs such as an operating system and a server program, screen data on webpages for presenting information on races to be provided to users, and others. Incidentally, the various programs may be acquired from other server devices or the like via the network 3, or may be recorded on recording media and read via a drive device (not shown), for example.

In addition, in the storage unit 12, a race information database 12a for receiving the race information and the like about the race to be held in each stadium from the host server 20 to store (hereinafter referred to as “race information DB 12a”), a purchase betting ticket database 12b for storing the information about the betting ticket purchased by the user (hereinafter referred to as “purchase betting ticket DB 12b”), an account database 12c for accepting the deposit information about the funds for the betting ticket purchase from the user through the terminal device 30 to store (hereinafter referred to as “account DB 12c.”), a member database 12d for storing information about the member (hereinafter referred to as “member DB 12d”.), and the like are constructed.

In the race information DB 12a (an example of a storage means), race information acquired from the host server 20 such as odds information and race results is stored in association with a race ID that specifies a race to be held in each stadium.

Here, examples of race information include, in addition to approximate odds information before the start of a race, racecourse names, weathers at racecourses, race conditions such as the types of racecourses, such as whether racecourses are dirt or grass, the names of races to be held, the names, ages, and weights of horses to participate in races, the state of racers such as the types of bicycles or boats (including the names, ages, weights, and others of horse jockeys or bicycle or boat players), and others. Further, the race information includes information on final odds at the end of sale of betting tickets, the order in a race when the race is finished and the order is fixed, a time difference between the first and the second, and others.

Further, in the race information DB 12a, odds information on each betting type and on each racer pattern is stored in association with race IDs.

As illustrated in FIG. 4, the race ID, the betting type, the buying target, the purchase amount, the purchase time, the cancellation flag, the cancellation application time, the refund amount, and the like of the purchased betting ticket are stored in the purchase betting ticket DB 12b in association with the user ID of the user purchasing the betting ticket.

Incidentally, data to be described in a field of the buying target is “1-2” when a betting type is exacta, and a racer number of a racer predicted to finish first is “1” and a racer number of a racer predicted to finish second is “2.” Moreover, when a betting type is quinella, a combination of racer numbers of racers predicted to finish first and second (combination of the racer number “1” and racer number “2” of the racers) also is “1-2.”

In addition, regarding the cancellation flag, the betting target of the betting type accepting the cancellation is turned ON. Regarding the refund amount, when there is an order of purchase from other users in the same betting type and buying target in the same race after the cancellation is accepted, the amount where the cancellation is established is entered. In addition, the balance of the cancellation request is given by purchase amount−refund amount.

The fund for a user to purchase a betting ticket is deposited in the account DB 12c, and its amount is stored in association with the user ID. For example, the user determines the budget of the betting ticket to purchase on the day the race is held, and transfers the amount for the budget amount to the account DB 12c by the terminal device 30 from the bank on the Internet and the like before purchasing the betting ticket. In addition, when the cancellation request of the betting ticket is established, the deposit is made into the account DB 12c depending on the amount where the cancellation is established. In addition, when the betting ticket wins, the payout is deposited in the account DB 12c. In addition, when the user purchases a betting ticket, the purchase amount is deducted from the balance of the user in the account DB 12c. Furthermore, the total deposit amount being the sum of the deposit from the bank and the like by the user and the deposit by the payout is stored in the account DB 12c.

In the member DB 12d, user information on users registered as members (users of a horse racing site) is registered, such as user IDs, names, addresses, telephone numbers, e-mail addresses, occupations, hobbies, purchase histories, and subjects and categories of interest of the users. In the member DB 12d, user IDs, login IDs, and passwords required for users to log in to the horse racing site from the terminal devices 30 are registered. Here, the login IDs and passwords are login information used for login processing (user authentication processing).

In the storage unit 12, files or the like of webpages written in a markup language or the like such as Hypertext Markup Language (HTML) or Extensible Markup Language (XML) to allow information from the horse racing site to be displayed on the terminal devices 30 are stored.

The input/output interface unit 13 performs interface processing between the communication unit 11 and the storage unit 12, and the system control unit 14.

The system control unit 14 is constituted by a central processing unit (CPU) 14a, read-only memory (ROM) 14b, and random-access memory (RAM) 14c, or the like. The system control unit 14 performs processing for mediating betting ticket sales and others by the CPU 14a reading and executing various programs stored in the ROM 14b and the storage unit 12.

### (2.2 Configuration and Function of Host Server 20)

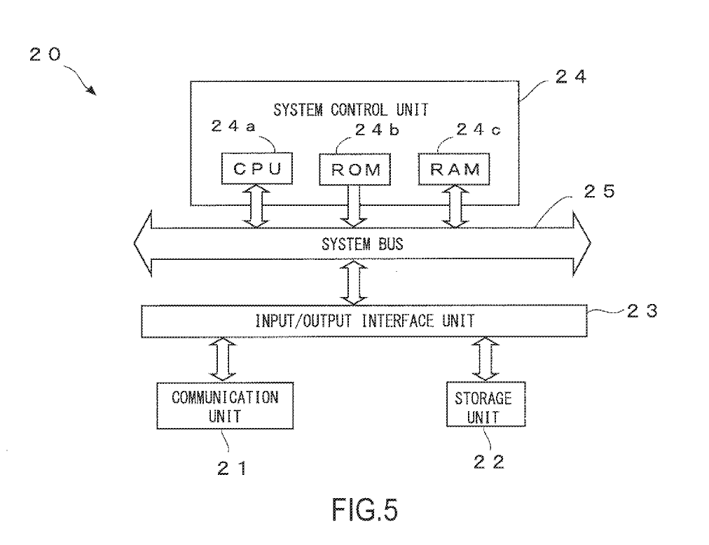

Next, the configuration and function of the host server 20 will be described with reference to FIG. 5.

FIG. 5 is a block diagram illustrating an example of a general configuration of the host server 20.

As shown in FIG. 5, the host server 20 includes a communication unit 21, a storage unit 22, an input/output interface unit 23, and a system control unit 24, and the system control unit 24 and the input/output interface unit 23 are connected via a system bus 25. The configuration and function of the host server 20 are almost identical to the configuration and function of the betting ticket sales mediation server 10, and thus difference in each component and each function of the betting ticket sales mediation server 10 will be mainly described.

The communication unit 21 performs control of the state of communication with the terminal devices 30 and the betting ticket sales mediation server 10 through the network 3, the local area network, or the like, and others.

In the storage unit 22, information on races and the like are stored.

The system control unit 24 is constituted by a CPU 24a, ROM 24b, and RAM 24c, or the like. The system control unit 24 performs processing of transmitting odds information to the betting ticket sales mediation server 10 and others by the CPU 24a reading and executing various programs stored in the ROM 24b and the storage unit 22.

### (2.3 Configuration and Function of Terminal Device 30)

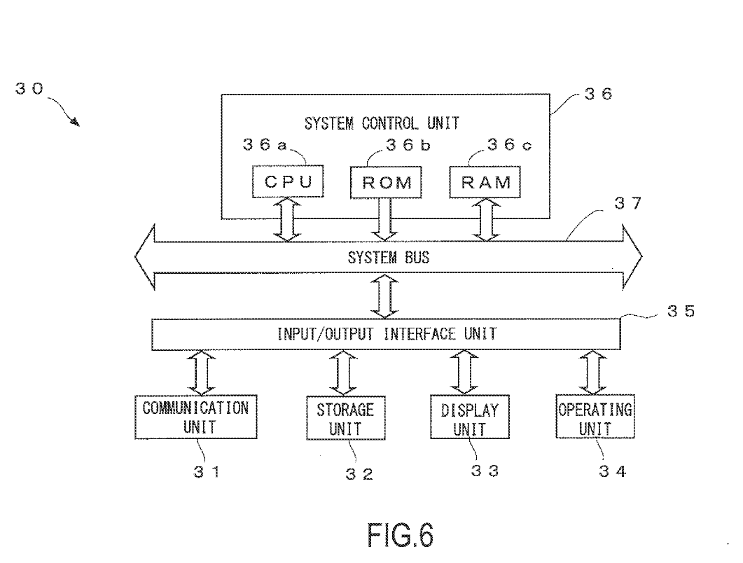

Next, the configuration and function of the terminal devices 30 will be described with reference to FIG. 6.

FIG. 6 is a block diagram illustrating an example of a general configuration of the terminal devices 30.

As shown in FIG. 6, a terminal device 30 functioning as a computer may be a personal computer, a portable wireless telephone such as a smartphone, or a mobile terminal such as a PDA, for example, and includes a communication unit 31, a storage unit 32, a display unit 33, an operating unit 34, an input/output interface unit 35, and a system control unit 36. The system control unit 36 and the input/output interface unit 35 are connected to each other via a system bus 37.

The communication unit 31 controls communication with the betting ticket sales mediation server 10 and others through the network 3. When the terminal device 30 is a mobile terminal device, the communication unit 31 has a wireless communication function for connection to a mobile communication network in the network 3.

The storage unit 32 has, for example, a hard disk drive or the like, and stores an operating system, a web browser program, a web browser tool bar program, and others. Moreover, the storage unit 32 stores dedicated software (so-called application) that displays information from the betting ticket sales mediation server 10 or purchases betting tickets, and others.

The display unit 33 is constituted by a liquid crystal display device, an electro luminescence (EL) device, or the like, for example. On the display unit 33, a top page screen of a horse racing site or a webpage of a race information table for the purchase of a betting ticket on a specific race is displayed by a web browser.

The operating unit. 34 is constituted by a keyboard and a mouse, or the like, for example. A user enters a response with the operating unit 34. When the display unit 33 is a touch switch type display panel such as a touch panel, the operating unit 34 acquires information on a location on the display unit 33 that the user contacts or comes close to.

The input/output interface unit 35 is an interface between the communication unit 31 and the storage unit 32, and the system control unit 36.

The system control unit 36 has a CPU 36a, ROM 36b, and RAM 36c, for example. In the system control unit 36, the CPU 36a reads and executes various programs stored in the ROM 36b, the RAM 36c, and the storage unit 32. For example, the system control unit 36 executes a web browser program, functioning as a web browser.

### [3. Operation of Betting Ticket Sales Mediation System]

Next, the operation of the betting ticket sales mediation system 1 according to one embodiment of the present invention will be described with reference to the drawings.

### (3.1 Purchase Operation of Betting Ticket)

First of all, the user (the first user, for example, “Mr. A.”) keeps the money necessary for the user to purchase the betting ticket deposited in the horse racing site beforehand. For example, the user keeps the funds for the betting ticket purchase deposited in his account opened in the betting ticket sales mediation server 10 beforehand before purchasing the betting ticket as the budget of the betting ticket to be purchased for the race to be held today. The user logs into the horse racing site of the betting ticket sales mediation server 10 from the terminal device 30 to perform the procedure of the deposit. The betting ticket sales mediation server 10 refers to the member DB 12d to perform the login processing, then accepts the deposit. Then, the betting ticket sales mediation server 10 stores the deposit information in the account corresponding to the user ID in the account DB 12c. Incidentally, the deposit procedure may be performed for each race by study of the situation of each race.

After the deposit is accepted, the user performs a study for purchasing the betting ticket, for example, based on the race information table, and selects the race number, the betting type, and the buying target in the web page or the application program to enter the purchase amount (acceptance amount) when the betting ticket to be purchased is determined.

Incidentally, the betting ticket sales mediation server 10 generates the race information table from the race information (including the odds information) transmitted sequentially from the host server 20.

After the input of the purchase amount, when the purchase button is clicked by the user, the betting ticket purchase information such as the race number, the betting type, the buying target, and the purchase amount is transmitted from the terminal device 30 to the betting ticket sales mediation server 10 together with the user ID.

Next, the betting ticket sales mediation system 1 accepts the betting ticket purchase information such as the betting type of the betting ticket, the buying target in the betting type, and the amount for each buying target. Specifically, the betting ticket sales mediation server 10 receives the betting ticket purchase information from the terminal device 30.

The betting ticket sales mediation server 10 stores the accepted betting ticket purchase information in the purchase betting ticket DB 12b in association with the user ID. That is, in the purchase betting ticket DB 12b, a new record is generated by using the user ID of the first user.

The betting ticket sales mediation server 10 totalizes the betting ticket purchase information accepted from each terminal device 30 including other users for each race, betting type, and buying target to generate the summary data at predetermined time intervals. The betting ticket sales mediation server 10 transmits the generated summary data to the host server 20.

Incidentally, the betting ticket sales mediation server 10 may transmit the summary data to the host server 20 at irregular intervals, not limited to the predetermined time intervals, or may transmit the summary data to the host server 20 in response to a request from the host server 20. In addition, the summary data is, for example, the data not including the user ID corresponding to each user's name, and obtained by totalizing the betting count for each race, betting type, and buying target.

### (3.2 Cancellation Operation of Betting Ticket)

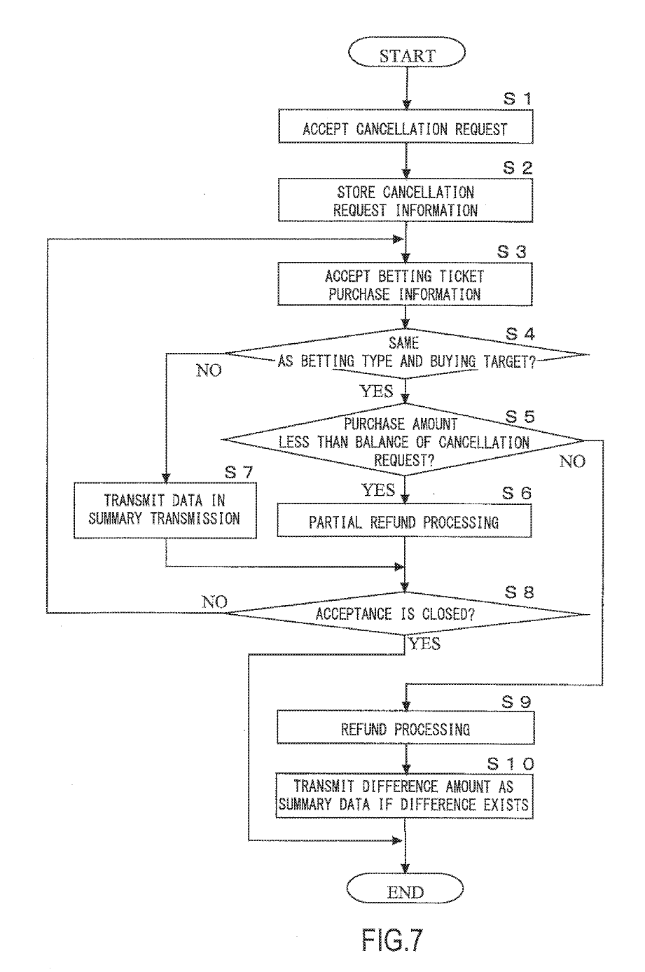

Next, the operation of the cancellation of the betting ticket will be described with reference to FIGS. 7 to 10.

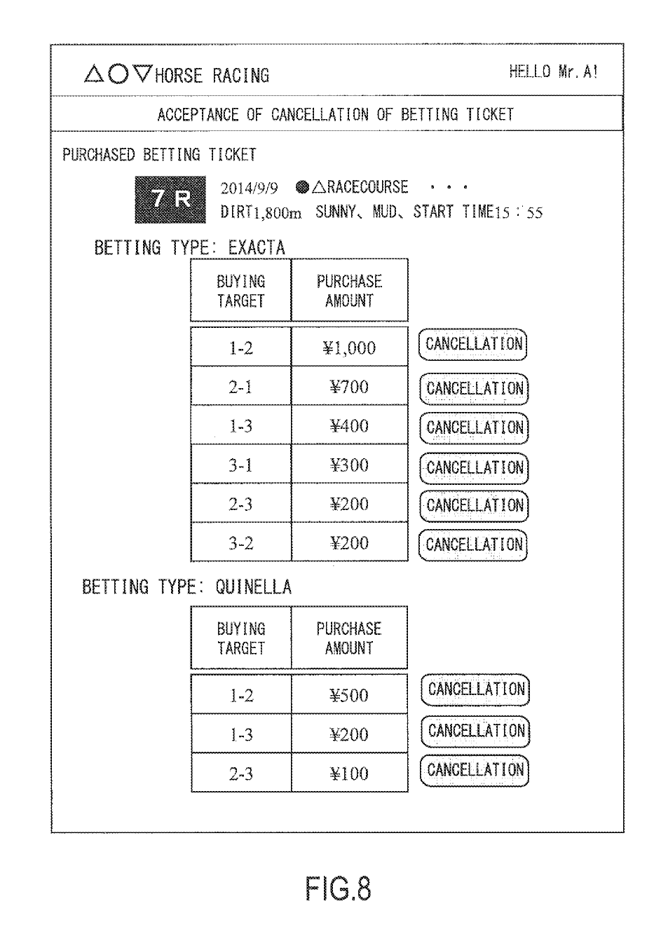

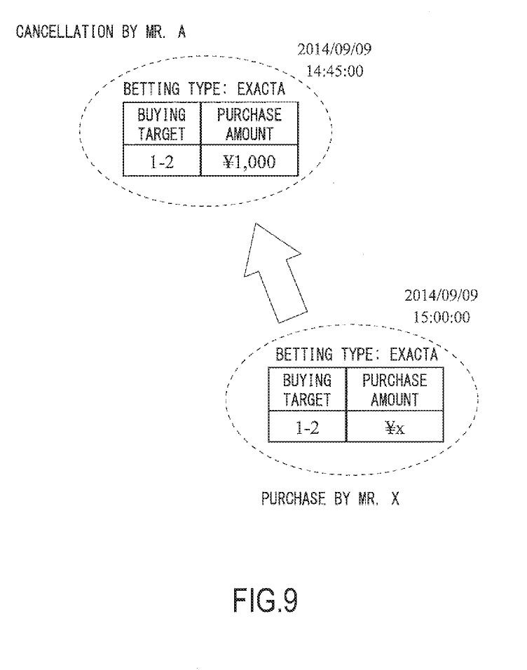

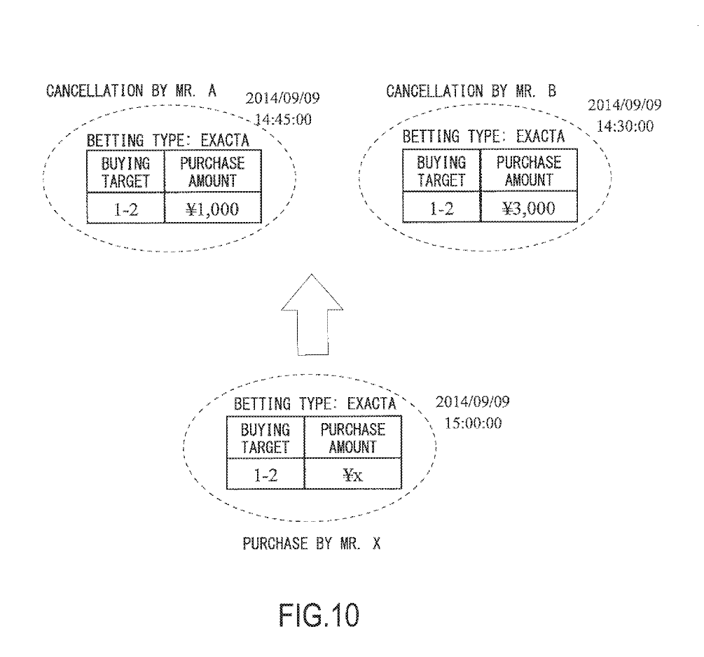

FIG. 7 is a flowchart illustrating an operation example of the betting ticket sales mediation system 1. FIG. 8 is a schematic diagram illustrating an example of a display of the terminal device 30. FIG. 9 is a schematic diagram illustrating an example of the purchase of a betting ticket of another user after cancellation of the betting ticket. FIG. 10 is a schematic diagram illustrating an example of the purchase of a betting ticket of another user after cancellation of the betting tickets of a plurality of persons.

As illustrated in FIG. 7, the betting ticket sales mediation system 1 accepts the cancellation request (step S1). Specifically, as illustrated in FIG. 8, the screen for accepting the cancellation of the betting ticket is displayed on the display unit 33 of the terminal device 30. The race number, the betting type, the buying target, and the purchase amount are displayed on the display unit 33 as the information on the purchased betting ticket of the user (the first user purchasing the betting ticket). The cancellation buttons are displayed on the display unit 33 so that the cancellation can be performed for each buying target of each betting type.

When the user selects the cancellation button of a buying target of a betting type desired to be cancelled, and then the terminal device 30 accepts the cancellation request, the terminal device 30 transmits the information on the cancellation request including the user ID, the race ID, the betting type, the buying target, and the purchase amount to the betting ticket sales mediation server 10.

Incidentally, as an example of the information capable of specifying the first user purchasing the betting ticket and the buying target of the purchased betting ticket, the purchase number of the betting ticket, the purchase ID and the like of the betting ticket will do instead of the user ID, the race ID, the betting type, the buying target, and the purchase amount.

When part of the amount of the purchased buying target is desired to be cancelled rather than the cancellation of the full amount of the purchased buying target, the user ID, the race ID, the betting type, the buying target, and the cancellation amount are included in the information about the cancellation request. Alternatively, the purchase ID and the cancellation amount of the betting ticket are included in the information about the cancellation request.

The betting ticket sales mediation server 10 receives the information about the cancellation request from the terminal device 30.

Thus, the betting ticket sales mediation server 10 functions as an example of the cancellation acceptance means that accepts from the first user the cancellation request of the purchased betting ticket including the information that can specify the first user purchasing the betting ticket and the betting type and buying target of the purchased betting ticket.

Next, the betting ticket sales mediation system 1 stores the information on the cancellation request (step S2). Specifically, the betting ticket sales mediation server 10 specifies the betting ticket corresponding to the cancellation based on the user ID, the race ID, the betting type, and the buying target of the cancellation request with reference to the purchase betting ticket DB 12b. The betting ticket sales mediation server 10 sets the cancellation flag of the specified betting ticket in the purchase betting ticket DB 12b to store the received time and the like at the cancellation application time.

Incidentally, the betting ticket sales mediation server 10 may specify the betting ticket corresponding to the cancellation based on the purchase ID of the betting ticket of the cancellation request.

For example, as illustrated in FIGS. 4 and 9, assume that the first user “Mr. A” (user ID “00111”) performs the cancellation on the betting ticket of the purchase amount for \1,000 in the buying target “1-2” of the betting type “an exacta” at 14:45:00 on Sep. 9, 2014.

Next, the betting ticket sales mediation system 1 accepts the betting ticket purchase information (step S3). Specifically, the betting ticket sales mediation server 10 receives the betting ticket purchase information from a terminal device 30 of a user (the second user) different from the terminal device 30 having transmitted the information on the cancellation request.

The betting ticket sales mediation server 10 generates a record of the betting ticket purchase information by using the user ID of the second user in the purchase betting ticket DB 12b.

For example, as illustrated in FIGS. 4 and 9, assume that the second user “Mr. X” (user ID “00xxx”) purchases the betting ticket of the buying target “1-2” of the betting type “an exacta” of the same race ID at the purchase amount for \300 at 15:00:00 on Sep. 9, 2014.

Next, the betting ticket sales mediation system 1 determines whether the betting type and the buying target are respectively the same (step S4). Specifically, the betting ticket sales mediation server 10 determines whether the race ID, the betting type, and the buying target of the betting ticket receiving the cancellation request and the race ID, the betting type, and the buying target of the betting ticket receiving the purchase are the same with reference to the purchase betting ticket DB 12b. More specifically, the betting ticket sales mediation server 10 searches for the betting ticket having the same race ID, betting type, and buying target in the record where the user ID is different from the user ID of the user requesting the purchase of the betting ticket, and the cancellation flag is set.

If the betting type and the buying target are respectively the same (YES in step S4), the betting ticket sales mediation system 1 determines whether the purchase amount in the same betting ticket as the second user apples for purchasing (the betting ticket having the same race ID, the same betting type and the same buying target) is less than the balance of the cancellation request (step S5). Specifically, the betting ticket sales mediation server 10 determines whether the purchase amount in the same betting ticket as the second user applies for purchasing is less than the balance of the cancellation request (purchase amount−refund amount) with reference to the purchase betting ticket DB 12b.

When the purchase amount in the same betting ticket as the second user applies for purchasing is less than the balance of the cancellation request (YES in step 35), the betting ticket sales mediation system 1 performs partial refund processing (step S6). Specifically, the betting ticket sales mediation server 10 determines to refund to the first user the amount obtained by adding the purchase amount in the same betting ticket as the second user applies for purchasing. If there is a determined refund amount, the betting ticket sales mediation server 10 determines to refund to the first user the amount obtained by adding the purchase amount in the same betting ticket as the second user applies for purchasing to the determined refund amount.

Next, the betting ticket sales mediation server 10 stores the amount obtained by adding the purchase amount in the same betting ticket as the second user applies for purchasing in the column of the refund amount of the record of the user performing the cancellation request in the purchase betting ticket DB 12b. The betting ticket sales mediation server 10 stores a new balance (the previous balance−the purchase amount in the same betting ticket as the second user applies for purchasing) in the column of the balance. For example, as illustrated in FIG. 4, the refund amount \300 and the balance \700 are stored. Thus, the partial refund processing is performed, whereby the cancellation is partly established. Thus, the case where a partial amount rather than the full amount of the cancellation request is refunded, that is, the cancellation is partly established is also an example of the establishment of the cancellation request.

Next, the betting ticket sales mediation server 10 deposits the refund amount in the account of the first user in the account DB 12c. Incidentally, the deposit into the account DB 12c may be performed after the acceptance of the betting ticket is closed, or the deposit may be sequentially performed each time the cancellation is partly established.

Incidentally, if the acceptance of the betting ticket is closed as it is, the cancellation of the balance cannot be performed, and therefore the balance \700 is finalized. At this time, the betting ticket sales mediation server 10 may set the purchase amount as the amount of the finalized balance \700 in the purchase betting ticket DR 12b, and may set the purchase amount from \1,000 to \700 assuming that the cancellation is partly established.

Thus, after acceptance of the cancellation request and before the betting ticket purchase deadline arrives, when accepting from the second user the purchase of the betting ticket of the betting type and the buying target which are the same as the betting type and the buying target of the betting ticket receiving the cancellation request from the first user, the betting ticket sales mediation server 10 functions as an example of the deposit means that deposits in the account of the first user depending on the amount of the betting ticket receiving the cancellation request from the first user and the amount of the betting ticket accepted from the second user. In addition, when the amount of the betting ticket receiving the cancellation request accepted from the first user is larger than the amount of the betting ticket of the same betting type and buying target accepted from the second user, the betting ticket sales mediation server 10 functions as an example of the deposit means that deposits the amount of the betting ticket of the same betting type and buying target accepted from the second user in the account of the first user.

After determination of the refund amount, the betting ticket sales mediation server 10 outputs for the first user the information indicating that the cancellation depending on the amount to be refunded is established. For example, the betting ticket sales mediation server 10 transmits the information indicating that the cancellation is partly established (an example of the establishment of the cancellation request) including the information on the determined refund amount to the terminal device 30 through the communication unit 11. Alternatively, the betting ticket information provision server 10 transmits the information indicating that the cancellation is partly established including the information on the determined refund amount to the email address associated with the member DB 12d as e-mail notification. Incidentally, each time the cancellation is partly established, the betting ticket sales mediation server 10 may output the information indicating that the cancellation is partly established for the first user, or may output the information including the finalized refund amount for the first user after the acceptance of the betting ticket is closed.

Thus, the betting ticket sales mediation server 10 functions as an example of the output means that outputs the information indicating that the cancellation request is established for the first user when the amount to be deposited is not zero.

If the betting type and the buying target are respectively not the same (NO in step S4), the betting ticket sales mediation system 1 transmits the data at the time of the summary transmission (step S7). Specifically, when the time to transmit the summary data comes, the betting ticket sales mediation server 10 transmits the summary data from which the name information such as the user ID of the second user is removed, the summary data including the betting ticket purchase information of the second user (the race ID, the betting type, the buying target, and the purchase amount) to be totalized to the host server 20.

Thus, the betting ticket sales mediation server 10 functions as an example of the transmission information determination means that determines the betting ticket purchase information not including the information on the name to be transmitted to the host server device depending on the amount of the betting ticket receiving the cancellation request accepted from the first user and the amount of the betting ticket of the same betting type and buying target accepted from the second user.

Next, the betting ticket sales mediation system 1 determines whether the acceptance of the betting ticket is closed (step S8). Specifically, the betting ticket sales mediation server 10 determines whether the acceptance of the betting ticket is closed regarding the race of the betting ticket of the cancellation request target. For example, as the deadline for acceptance of the betting ticket, the cases such as a predetermined time before the time at which a predetermined race is started, and when the information about the deadline for acceptance of the betting ticket is received from the host server 20 can be cited.

If the acceptance of the betting ticket is not closed (NO in step S8), the process returns to step S3, and the betting ticket sales mediation server 10 accepts the purchase of a new betting ticket.

If the new betting ticket purchase information having the same race ID, betting type, and buying target of the betting ticket receiving the cancellation request is accepted by the deadline of the acceptance of the betting ticket, in step S5, the betting ticket sales mediation server 10 determines whether the purchase amount in the betting ticket having the same betting type and buying target in the new purchase is less than the balance of the cancellation request.

If the purchase amount in the betting ticket having the same betting type and buying target in the new purchase (for example, \500) is less than the balance of the cancellation request (for example, \700), in step S6, the betting ticket sales mediation server 10 stores the amount obtained by adding the purchase amount in the same betting ticket for a new purchase (for example, \800) in the column of the refund amount of the record of the user performing the cancellation request, and stores a new balance in the column of the balance (for example, \200) in the purchase betting ticket DB 12b. The processes from step S3 to step S8 are repeated until the balance becomes zero, or until the acceptance of the purchase of the betting ticket is closed.

If the purchase amount is not less than the balance of the cancellation request (NO in step S5), the betting ticket sales mediation system 1 performs the refund processing (step S9). Specifically, the betting ticket sales mediation server 10 determines to refund the amount of the betting ticket on which the cancellation request is performed to the first user. Incidentally, if part of the amount is desired to be cancelled, the betting ticket sales mediation server 10 determines to refund the cancellation amount to the first user.

Next, the betting ticket sales mediation server 10 enters “\0” in the balance column of the record of the user performing the cancellation request in the purchase betting ticket DB 12b. The amount in the column of the refund amount is the same amount as the purchase amount. Incidentally, the betting ticket sales mediation server 10 may erase the record of the user performing the cancellation request.

Next, the betting ticket sales mediation server 10 deposits the refund amount in the account of the first user in the account DB 12c. Incidentally, the deposit into the account DB 12c may be performed after the acceptance of the betting ticket is closed, or the deposit may be performed when the cancellation request is established.

Thus, when the amount of the betting ticket accepted as the cancellation request accepted from the first user is larger than the amount of the betting ticket of the same betting type and buying target accepted from the second user, the betting ticket sales mediation server 10 functions as an example of the deposit means that deposits the amount of the betting ticket of the same betting type and buying target accepted from the second user in the account of the first user.

After determination of the refund amount, the betting ticket sales mediation server 10 outputs for the first user the information indicating that the cancellation depending on the amount to be refunded is established. For example, the betting ticket sales mediation server 10 transmits the information indicating that all the cancellation of the cancellation request is established to the terminal device 30 through the communication unit 11. Alternatively, the betting ticket information provision server 10 transmits the information indicating that all the cancellation of the cancellation request is established (an example of the establishment of the cancellation request) to the e-mail address associated with the member DB 12d as the e-mail notification. After the acceptance of the betting ticket is closed, the information indicating that all the cancellation is established may be output for the first user.

Thus, the betting ticket sales mediation server 10 functions as an example of the output means that outputs the information indicating that the cancellation request is established for the first user when the amount to be deposited is not zero.

Next, if there is a difference, the betting ticket sales mediation system 1 transmits the difference amount as the summary data (step S10). Specifically, when the time to transmit the summary data comes, the betting ticket sales mediation server 10 transmits the summary data from which the name information such as the user ID of the second user is removed, the summary data including the information of the betting ticket (the betting ticket having the same race ID, betting type, and buying target) in the amount obtained by subtracting the balance of the cancellation request from the purchase amount in the same betting ticket as the second user applies for purchasing (difference amount) to be totalized to the host server 20, and ends the processing of a series of the cancellation.

Thus, if the amount of the betting ticket receiving the cancellation request accepted from the first user is less than the amount of the betting ticket of the same betting type and buying target accepted from the second user, the betting ticket sales mediation server 10 functions as an example of the transmission information determination means that determines to transmit the betting ticket purchase information not including the information on the name based on the difference between these purchase amounts to the host server device.

Alternatively, if the acceptance of the betting ticket is closed (YES in step S8), the betting ticket sales mediation system 1 ends the processing of a series of the cancellation.

Incidentally, after the race is finished, in the account DB 12c, the amount for the established cancellation is deposited in the account of the first user.

As described above, according to the present embodiment, the refund can be performed to the account of the first user depending on the amount of the betting ticket receiving the cancellation request from the first user (“Mr. A”) and the amount of the betting ticket of the same betting type and buying target accepted from the second user, and therefore the cancellation of the betting ticket can be performed without the cancellation request to the host system of the host.

In addition, if the determined amount to refund is not zero, the information indicating that the cancellation request is established is output for the first user, whereby the user requesting the cancellation can check that the cancellation is partly established (part of the amount of the cancellation request is refunded) or fully established (the full amount of the cancellation request is refunded).

In addition, when the amount of the betting ticket receiving the cancellation request accepted from the first user is larger than the amount of the betting ticket of the same betting type and buying target accepted from the second user, if the amount of the betting ticket of the same betting type and buying target accepted from the second user is determined to be refunded to the first user, the betting ticket purchase information of the purchase amount from the second user does not need to be transmitted to the host side, and the purchase amount of the second user is refunded to the first user as a partial refund, whereby the cancellation can be partly performed.

### [4. Modification]

Next, the case where the cancellation request comes from a plurality of users will be described with reference to FIG. 10.

FIG. 10 is a schematic diagram illustrating an example of the purchase of a betting ticket of another user after cancellation of the betting tickets of a plurality of persons.

As illustrated in FIG. 10, a plurality of cancellation requests to the betting ticket of the same betting type and buying target of the same race will do.

Assume that as illustrated in FIG. 10, to the buying target “1-2” of the betting type “an exacta”, there is a cancellation request for \1,000 from “Mr. A” (an example of the first user), and a cancellation request for \3,000 from “Mr. B” (an example of the first user).

Assume that after the cancellation requests of “Mr. A” and “Mr. B”, “Mr. X” of an example of the second user purchases the betting ticket with the same buying target “1-2” of the same betting type “an exacta” for \x.

If the purchase amount \x of “Mr. X” is \4,000 (the total of \1,000 of “Mr. A” and \3,000 of “Mr. B” is set as the balance) or more, this yields “NO” in step S5, and in step S9, the betting ticket sales mediation server 10 enters “\0” in the balance column of the record of the users “Mr. A” and “Mr. B” performing the cancellation request in the purchase betting ticket DB 12b.

If the purchase amount \x of “Mr. X” is less than \4,000, this yields “YES” in step S5, and the betting ticket sales mediation server 10 performs partial refund processing to the users “Mr. A” and “Mr. B”.

In this case, for example, the betting ticket sales mediation server 10 distributes the amount \x to the users “Mr. A” and “Mr. B” evenly with \x/2 each. Thus, the amount obtained by division by the number of users performing the cancellation request (the distribution amount) is distributed to each user, whereby a sense of fairness is obtained.

The betting ticket sales mediation server 10 stores the amount obtained by adding the distribution amount in the column of the refund amount of the record of each user performing the cancellation request in the purchase betting ticket DB 12b. The betting ticket sales mediation server 10 stores a new balance (previous balance−distribution amount) in the column of the balance. In the account of the user “Mr. A” and the account of the user “Mr. B” in the account DB 12c, the respective amounts are deposited.

Incidentally, the betting ticket sales mediation server 10 may determine the distribution amount to be distributed to the users “Mr. A” and “Mr. B” out of the amount \x depending on the time of the cancellation request. For example, the time of the cancellation request of the user “Mr. B” is earlier, and therefore the distribution of the user “Mr. B” is increased.

Thus, with respect to the betting ticket of the same betting type and buying target, if the amount obtained by the sum of the amounts of the betting tickets (for example, \4,000) in the cancellation requests accepted from a plurality of first users (for example, “Mr. A” and “Mr. B”) is larger than the purchase amount of the betting ticket of the same betting type and buying target (for example, \x) accepted from the second user (for example, “Mr. X”), the refund amount (the distribution amount) to be refunded to each user is determined depending on each time of the cancellation request accepted from the plurality of users in the purchase amount of the betting ticket of the same betting type and buying target accepted from the second user.

In this case, the partial cancellation can be performed due to the refund with a greater sense of fairness depending on the time of the cancellation request with respect to each first user requesting the cancellation.

Incidentally, the refund amount to be refunded to each user may be determined depending on the user information of each user in a plurality of the first users. The distribution amount for the first user performing the cancellation request in the buying target of another betting type is increased. Alternatively, the distribution amount for the first user whose cancellation is already not established in the buying target of another betting type (including the partial establishment by the partial refund processing) is increased.

With respect to the betting ticket of the same betting type and buying target, if the total amount of the amounts of the betting tickets in the cancellation request accepted from a plurality of users including the first user is larger than the amount of the betting ticket of the same betting type and buying target accepted from the second user, the refund amount to be refunded to each user is determined to be deposited in the account of each user depending on the user information of each user of the plurality of users in the amount of the betting ticket of the same betting type and buying target accepted from the second user.

In this case, the refund in accordance with a predetermined reference depending on the user information of each user is performed to each first user requesting the cancellation, whereby the partial cancellation with a greater sense of fairness can be performed.

Incidentally, if there is a new cancellation request before the summary data are transmitted, the betting ticket sales mediation server 10 may search whether there is the same race ID, betting type, and buying target as the betting ticket to be summarized before transmission as in step S4. The betting ticket sales mediation server 10 may perform the partial refund processing as in step S6, or the refund processing as in step S9 depending on the amount of the new cancellation request and the amount of the betting ticket to be summarized before transmission as in step S5.

In addition, after the establishment of the cancellation request, in the refund processing or the partial refund processing, points may be given to the first user instead of the deposit in the account of the first user.

Further, the present invention is not limited to the above embodiment. The above embodiment is illustrative, and anything having components substantially identical to the technical idea described in the claims of the present invention and providing similar functions and effects is included in the technical scope of the present invention.

### EXPLANATION OF REFERENCE NUMERALS

1 betting ticket sales mediation system
10 betting ticket sales mediation server (betting ticket sales mediation device)
12b purchase betting ticket DB
12c account DB
20 host server (host server device)
30 terminal device (user terminal)

1. A betting ticket sales mediation device that accepts a purchase of a betting ticket of a racing from a user terminal, and transmits betting ticket purchase information not including information about a name of a user purchasing the betting ticket to a host server device hosted by the racing, the betting ticket sales mediation device comprising:
at least one memory configured to store computer program code;
at least one processor configured to access said at least one memory, read said computer program code, and operate according to said computer program code, said computer program code including:
cancellation acceptance code configured to cause at least one of said at least one processor to accept a cancellation request of the purchased betting ticket including information that can specify a first user purchasing the betting ticket and a betting type and a buying target of the purchased betting ticket from a user terminal of the first user;
deposit code configured to cause at least one of said at least one processor to deposit in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and
output code configured to cause at least one of said at least one processor to output, for the first user, information indicating that a cancellation depending on the amount to be deposited out of the cancellation request is established when the amount to be deposited is not zero.

2. The betting ticket sales mediation device according to claim 1, further comprising
transmission information determination code configured to cause at least one of said at least one processor to determine, when an amount of the betting ticket receiving the cancellation request accepted from the first user is less than an amount of a betting ticket of the same betting type and buying target accepted from the second user, to transmit betting ticket purchase information not including information on the name based on a difference between these purchase amounts to the host server device.

3. The betting ticket sales mediation device according to claim 1,
wherein when an amount of the betting ticket receiving the cancellation request accepted from the first user is larger than an amount of the betting ticket of the same betting type and buying target accepted from the second user, the deposit code causes at least one of said at least one processor to deposit an amount of the betting ticket of the same betting type and buying target accepted from the second user in an account of the first user.

4. The betting ticket sales mediation device according to claim 3,
wherein with respect to a betting ticket of the same betting type and buying target, when a total amount of amounts of betting tickets in the cancellation requests accepted from a plurality of users including the first user is larger than an amount of the betting ticket of the same betting type and buying target accepted from the second user, the deposit code causes at least one of said at least one processor to deposit, in an account of each of the users, an amount depending on each time of cancellation requests accepted from the plurality of users in an amount of the betting ticket of the same betting type and buying target accepted from the second user.

5. The betting ticket sales mediation device according to claim 3,
wherein with respect to a betting ticket of the same betting type and buying target, when a total amount of amounts of betting tickets in the cancellation requests accepted from a plurality of users including the first user is larger than an amount of the betting ticket of the same betting type and buying target accepted from the second user, the deposit code causes at least one of said at least one processor to deposit, in an account of each of the users, an amount depending on user information of each user in the plurality of users in an amount of the betting ticket of the same betting type and buying target accepted from the second user.

6. A betting ticket sales mediation method of a betting ticket sales mediation device that accepts a purchase of a betting ticket of a racing from a user terminal, and transmits betting ticket purchase information not including information about a name of a user purchasing the betting ticket to a host server device hosted by the racing, the betting ticket sales mediation method performed by a computer system having at least one processor and comprising:
accepting, from a first user, a cancellation request of the purchased betting ticket including information that can specify the first user purchasing the betting ticket and a betting type and a buying target of the purchased betting ticket;
depositing in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and
outputting, for the first user, information indicating that a cancellation depending on the amount to be deposited out of the cancellation request is established when the amount to be deposited is not zero.

7. A non-transitory computer-readable recording medium recording a program for a betting ticket sales mediation device that accepts a purchase of a betting ticket of a racing from a user terminal, and transmits betting ticket purchase information not including information about a name of a user purchasing the betting ticket to a host server device hosted by the racing, the program causing a computer to:
accept, from a first user, a cancellation request of the purchased betting ticket including information that can specify the first user purchasing the betting ticket and a betting type and a buying target of the purchased betting ticket;
deposit in an account of the first user depending on an amount of a betting ticket receiving the cancellation request from the first user and an amount of a betting ticket accepted from a second user, after acceptance of the cancellation request and before a betting ticket purchase deadline arrives and when accepting from the second user a purchase of a betting ticket of a betting type and a buying target same as the betting type and the buying target of the betting ticket receiving the cancellation request from the first user; and
output, for the first user, information indicating that a cancellation depending on the amount to be deposited out of the cancellation request is established when the amount to be deposited is not zero.
